(19) United States
(12) Patent Application Publication
(10) Pub. No.: US 2008/0046966 A1
(43) Pub. Date: Feb. 21, 2008

(54) METHODS AND APPARATUS TO PROCESS NETWORK MESSAGES

(76) Inventors: Richard Chuck Rhoades, Decatur, TX (US); James Dwayne Rushing, McKinney, TX (US); Scott Andrew Newman, Little Elm, TX (US); John-Paul Andrew Roadman, Carrollton, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/462,198

(22) Filed: Aug. 3, 2006

(51) Int. Cl. H04L 9/32

(52) U.S. Cl. 726/2

(57) ABSTRACT

Methods and apparatus to process network messages are disclosed. A disclosed example method of processing authentication result messages in a network having a server and at least one network device that sends an authentication result message to the server comprises receiving the authentication result message from the network device, providing the authentication result message to one of two or more processing modules of the server, the one of two or more processing modules to process the authentication result message to extract data from the authentication result message, and sending the data to a destination.

### FIELD OF THE DISCLOSURE

This disclosure relates generally to network messages, and, more particularly, to methods and apparatus to process network messages.

### BACKGROUND

Communication networks and/or systems rely on authentication to verify user and/or computer identities and/or authorize access to communication resources and/or services. For example, a user logging into a communication service such as, for example, Internet access, may have their login and/or password verified by their Internet service provider (ISP). Such authentication may be performed by, for example, a Remote Authentication Dial-In User Service (RADIUS) server that, in addition to performing the authentication, logs and/or records each attempted authentication and whether or not the authentication succeeded. Such logs and/or records are useful to, for example, identify patterns of unauthorized and/or attempted unauthorized access. Such authentication result information and/or logs are sent using, for example, a User Datagram Protocol (UDP) packet to a central server and/or platform for processing.

### BRIEF DESCRIPTION OF THE DRAWINGS

FIG. 1 is a diagram of an example communication system including a message processing server constructed in accordance with the teachings of the invention.

FIGS. 2A and 2B illustrate example payloads of authentication result messages.

FIG. 3 illustrates an example manner of implementing the example message processing servers of FIG. 1.

FIGS. 4A and 4B illustrate example authentication log database records.

FIG. 5 is a flowchart representative of example machine accessible instructions that may be executed to implement the example message receiver modules of FIG. 3.

FIG. 6 is a flowchart representative of example machine accessible instructions that may be executed to implement the example message processing modules of FIG. 3.

FIG. 7 is a schematic illustration of an example processor platform that may be used and/or programmed to execute the example machine accessible instructions illustrated in FIGS. 5 and/or 6 to implement the example message receiver modules, the example message processing modules and/or, more generally, the example message processing servers of FIG. 1 and/or 3.

### DETAILED DESCRIPTION

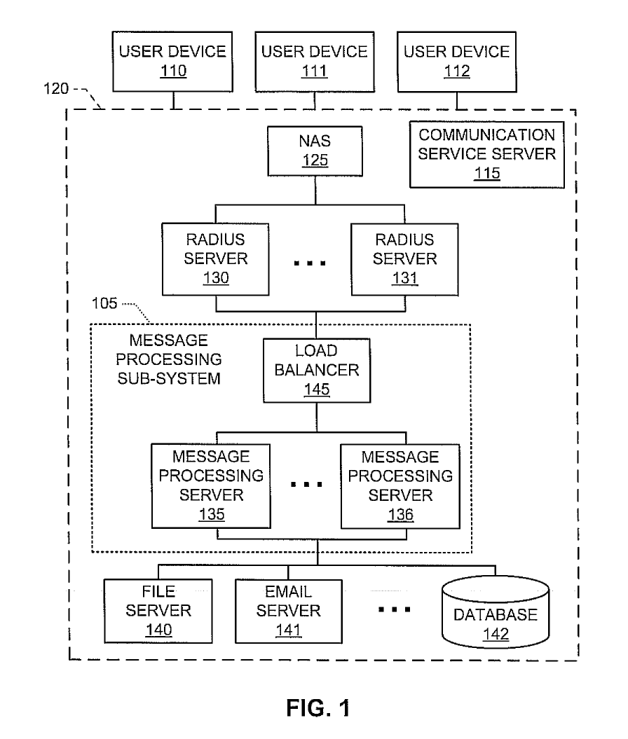

FIG. 1 is a schematic diagram of an example communication system including a message processing sub-system 105. The example system of FIG. 1 may be used to provide any of a variety of communication services such as, for example, data, video, audio, Internet Protocol (IP) television (TV) (a.k.a. IPTV), telephone, gaming, Internet, messaging, electronic mail, etc. services to any of a variety of user devices, three of which are shown in FIG. 1 with reference numerals 110, 111 and 112. Example user devices 110, 111 and 112 may include any type of communication device including, for example, personal digital assistants, media players such as iPods®, cellular phones, voice over IP (VoIP) phones, smart phones, laptop computers, personal computers, set-top boxes, digital video recorders, cable modems, satellite transceivers, and/or residential gateways.

The example user devices 110, 111 and 112 of FIG. 1 may be connected to any of a variety of communication networks and/or communication systems 120 such as the Internet via any of a variety of transmission paths (e.g., wired, wireless and/or satellite).

To provide the communication services for and/or to the example user devices 110, 111 and 112, the example communication system 120 of FIG. 1 includes any of a variety of communication service servers, one of which is shown in FIG. 1 with reference numeral 115. Example communication service servers 115 include an IPTV server, a Unified Communications^{SM} messaging server, a VoIP gateway, a media server, an Internet protocol (IP) multimedia system (IMS), etc.

To manage access of the example user devices 110, 111 and 112 to the example communication system 120 and/or the example communication service server 115, the example communication system 120 of FIG. 1 includes any of a variety of network access servers (NAS), one of which is illustrated in FIG. 1 with reference numeral 125. The example NAS 125 of FIG. 1 enables an Internet service provider (ISP) to provide customers with Internet access via one of the example user devices 110, 111 and 112. The example NAS 125 has interfaces to both (a) a telecommunication service provider such as a phone company that provides a communication path between the user devices 110, 111 and 112 and the example communication system 120 and (b) to the Internet backbone. The example NAS 125 of FIG. 1 authenticates users requesting login by, for example, verifying a user name and/or password, and then, if the user is successfully authenticated, allows data to pass between an authenticated user device 110, 111 and 112 and one or more hosts (e.g., servers or computers) elsewhere on the Internet (e.g., the example communication service server 115). The example NAS 125 of FIG. 1 may also perform other functions such as, for example, VoIP, fax-over-IP, and voicemail-over-IP as well.

To provide authentication services, the example communication system 120 of FIG. 1 includes any of a variety of authentication servers, two of which are illustrated in FIG. 1 with reference numerals 130 and 131. Example authentication servers 131, 131 are Remote Authentication Dial-In User Service (RADIUS) servers implemented in accordance with one or more current and/or future applicable standards and/or specifications such as, for example, the Internet Engineering Task Force (IETF) Request For Comment (RFC) 2865. Of course, other types of servers may be used. The example RADIUS servers 130, 131, in addition to performing authentication, log and/or record each requested and/or attempted authentication and whether or not each authentication was successful (i.e., accepted) and/or failed (i.e., rejected).

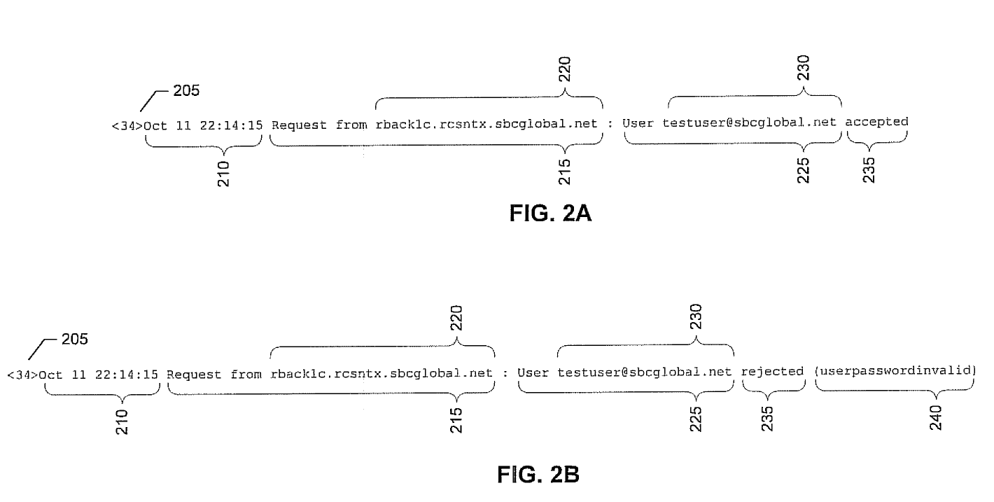

In the illustrated example of FIG. 1, authentication logs and/or records (i.e., authentication results messages) are sent by each RADIUS server 130, 131 to the example message processing sub-system 105 for processing. In the example of FIG. 1, an authentication result message is sent for each authentication request using, for example, a User Datagram Protocol (UDP) datagram packet. However, persons of ordinary skill in the art will appreciate that the results of two or more authentication requests may be sent together in a UDP datagram. Moreover, any variety of packet and/or data transmission protocol may be used to send authentication result messages. Example payloads of authentication result messages are discussed below in connection with FIGS. 2A and 2B.

While only a single NAS 125 is illustrated in FIG. 1, the example communication system 120 of FIG. 1 may include any number and/or variety of network access servers 125. Further, the example user devices 110, 111 and 112 and/or customers may be partitioned to, assigned to and/or served by NASs 125 using any variety of method(s), technique(s), logic(s) and/or algorithm(s). Additionally or alternatively, the example communication system 120 of FIG. 1 may include any number and/or variety of authentication servers 130, 131.

While for simplicity the following disclosure is made with respect to authentication of users and the processing of authentication result messages, persons of ordinary skill in the art will readily recognize that the methods and apparatus disclosed herein may be used to process any of a variety of network messages such as network element error messages (e.g., generated by, for example, routers and/or switches) or network access attempt messages (e.g., generated by, for example, security equipment and/or network firewalls).

Moreover, while the following disclosure is made with respect to the example topology and interconnections illustrated in FIG. 1, persons of ordinary skill in the art will recognize that any number and/or variety of user devices 110, 111 and 112, communication service servers 115, communication systems 120, NASs 125, RADIUS or authentication servers 130, 131 and/or message processing sub-systems 105 may be communicatively coupled in any of a variety of topologies and/or using any of a variety of communication path(s), technology(-ies) and/or protocol(s) may be used with the methods and apparatus disclosed herein.

Further, while the following disclosure is made with reference to the transport of authentication result messages in text-based UDP datagrams, persons of ordinary skill in the art will readily recognize that any of a variety of packets and/or data transmission format(s) and/or structures may be used to transport authentication result messages and/or, more generally, network messages. For example, authentication result and/or network messages could be transported using a binary packet format.

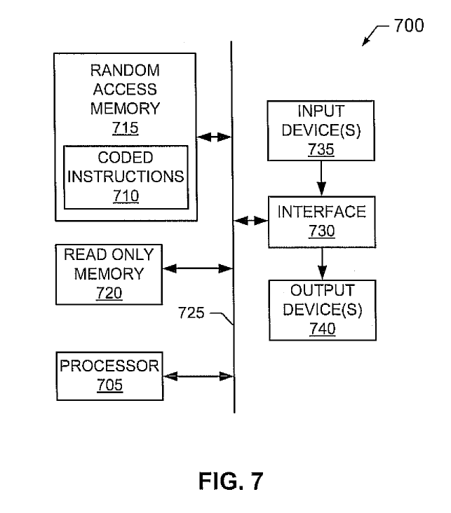

To process authentication result messages sent by the example RADIUS servers 130, 131, the example message processing sub-system 105 of FIG. 1 includes any number of message processing servers constructed in accordance with the teachings of the invention, two of which are shown with reference numbers 135 and 136 in FIG. 1. In one example, the example message processing servers 135, 136 of FIG. 1 process UDP datagrams containing authentication result messages as they are received (i.e., essentially in real-time) so that authentication result data contained in the datagrams is available in, to and/or via any of a variety of destinations at substantially the same time as authentication requests are received and processed by the RADIUS servers 130, 131. The example message processing servers 135, 136 of FIG. 1 process network messages in parallel and are designed to handle a significant number of messages per second (e.g., forty-five (45) million UDP datagrams a day). In the illustrated example, each of the message processing servers 135, 136 is implemented as machine accessible instructions executed by any of a variety of processor (e.g., the example processor 700 of the example computing platform of FIG. 7).

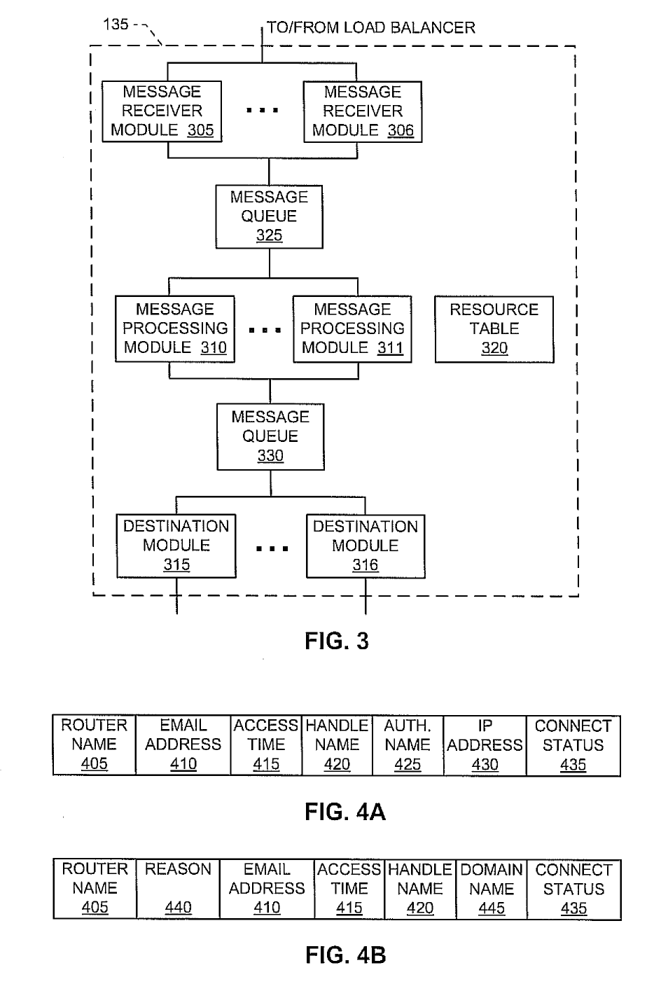

The example message processing sub-system 105 of FIG. 1 extracts and/or processes authentication result data received via UDP datagrams substantially in concert with the authentication request processing performed by the authentication servers 130, 131. Thus, for example, tools that utilize such authentication result data are able to more quickly (e.g., near real-time) detect network problems, detect authentication attacks, detect security attacks, etc. An example implementation of the message processing servers 135, 136 of FIG. 1 is discussed below in connection with FIGS. 3 and 5-6.

Example destinations for authentication result data include a file server 140, an electronic mail server 141 and/or a database 142. However, any number and/or variety of destinations may be implemented. Additionally or alternatively, more than one of the illustrated destinations 140-142 may be present. Example database records for storing authentication result data are discussed below in connection with FIGS. 4A and 4B.

To balance the processing load among the message processing servers 135, 136, the example message processing sub-system 105 of FIG. 1 includes any of a variety of load balancers 145 such as BIG-IP® from F5 Networks, Inc. The example load balancer 145 of FIG. 1 receives UDP datagrams sent to the example message processing sub-system 105 by any of the RADIUS servers 130, 131 and sends and/or queues received messages for processing by one of the example message processing servers 135, 136. Any of a variety of method(s), technique(s), logic and/or algorithm(s) may be used to select and/or determine which of the message processing servers 135, 136 processes a particular message. For example, the example load balancer 145 may seek to ensure that received messages are processed by the example message processing servers 135, 136 in the order in which they were received while minimizing the processing latency through the example message processing servers 135, 136.

Persons of ordinary skill in the art will readily appreciate that if the number of datagrams being processed by the example message processing sub-system 105 is small enough that a single message processing server 135, 136 is sufficient, the example message processing sub-system need not include the load balancer 145.

The example system of FIG. 1 sends authentication result information in UDP datagrams that contain a text-based payload that represents the authentication result information. FIG. 2A illustrates an example text-based payload (i.e., an authentication result string) of an authentication accepted and/or successful UDP datagram. To specify the facility failure severity code and/or priority of the UDP datagram, the example authentication string of FIG. 2A includes a priority (PRI) element 205. For an authentication result UDP datagram the priority element 205 is always the text string “<34>”.

To specify the time and/or date when the RADIUS server 130, 131 of FIG. 1 received the authentication request, the example authentication string of FIG. 2A includes a timestamp element 210. The example timestamp element of FIG. 2A specifies the date and time that the authentication request was received at the RADIUS server 130, 131.

To identify the NAS 125 via which the authentication request was initiated, the example authentication string of FIG. 2A includes a request-from element 215. The example request-from element 215 of FIG. 2A includes an address element 220 that contains the uniform resource locator (URL) address of the NAS 125 that sent the authentication to the RADIUS server 130, 131.

To identify the user that initiated the authentication request, the example authentication string of FIG. 2A includes a user element 225. The example user element 225 of FIG. 2A includes an email address element 230 that contains the email address of the user.

To identify the result of the authentication request (e.g., accepted), the example authentication string of FIG. 2A includes a result element 235. Because the example authentication result string illustrated in FIG. 2A corresponds to an authentication accepted UDP datagram, the example result element 235 of FIG. 2A contains the text string “accepted”.

FIG. 2B illustrates an example payload of an authentication rejected and/or failed UDP datagram. Many of the elements of the authentication result string illustrated in FIG. 2B are identical to those discussed above in connection with FIG. 2A and, thus, the description of identical elements are not repeated here. Instead, identical elements are illustrated with identical reference numerals in FIGS. 2A and 2B, and the interested reader is referred back to the descriptions presented above in connection with FIG. 2A.

Because the example authentication result string illustrated in FIG. 2B corresponds to an authentication rejected UDP datagram, the example result element 235 of FIG. 2B contains the text string “rejected”.

To identify the reason for the authentication rejection, the example authentication string of FIG. 2B includes a reason element 240. The example reason element 240 of FIG. 2B indicates that the reason for the authentication rejection was an invalid user password.

While example authentication result strings are illustrated in FIGS. 2A-B, persons of ordinary skill in the art will readily appreciate that the elements of FIGS. 2A-B could have been combined, split, ordered, re-arranged, and/or eliminated in any of a variety of ways. Further, authentication result strings may include additional elements than those illustrated in FIG. 2A and/or 2B and/or may include more than one of any or all of the illustrated elements. Persons of ordinary skill in the art will also readily appreciate that the methods and apparatus to process network messages disclosed herein can be applied to network messages and/or UDP datagrams having any of a variety of elements, text strings and/or text string formats.

FIG. 3 illustrates an example manner of implementing the example message processing servers 135, 136 of FIG. 1. However, for ease of discussion, the example device of FIG. 3 will be referred to as a message processing server 135. In the illustrated example, the message processing server 135 is implemented as machine accessible instructions executed by any of a variety of single-threaded and/or multi-threaded processor(s) (e.g., the example processor 700 of the example computing platform of FIG. 7). The example message processing server 135 may also be executed by any of a variety of computing devices and/or platforms having multiple concurrently-executing processors. Additionally or alternatively, some or all of the example message processing server 135 of FIG. 3 may be implemented using an application specific integrated circuit (ASIC), a programmable logic device (PLD), a field programmable logic device (FPLD), discrete logic, hardware, firmware, etc. Also, some or all of the example message processing server 135 may be implemented manually or as combination(s) of any of the foregoing techniques, for example, a combination of firmware, software and/or hardware.

The example message processing server 135 of FIG. 3 is implemented using replaceable, interoperable and/or extendable modules as illustrated in FIG. 3. The use of modules to implement the example message processing server 135 allows the introduction, modification and/or removal of functionality (e.g., as standards and/or protocols evolve, are changed and/or are replaced) without requiring modification of other modules. For example, as discussed below, destination modules can be added to support additional destinations 140-142 without the modification of existing message processing modules. Moreover, because the example message processing server 135 of FIG. 3 is modular and/or multi-threaded it can be readily scaled for any of a variety of multi-processor computers, servers and/or computing platforms used to implement the message processing server 135 of FIG. 3.

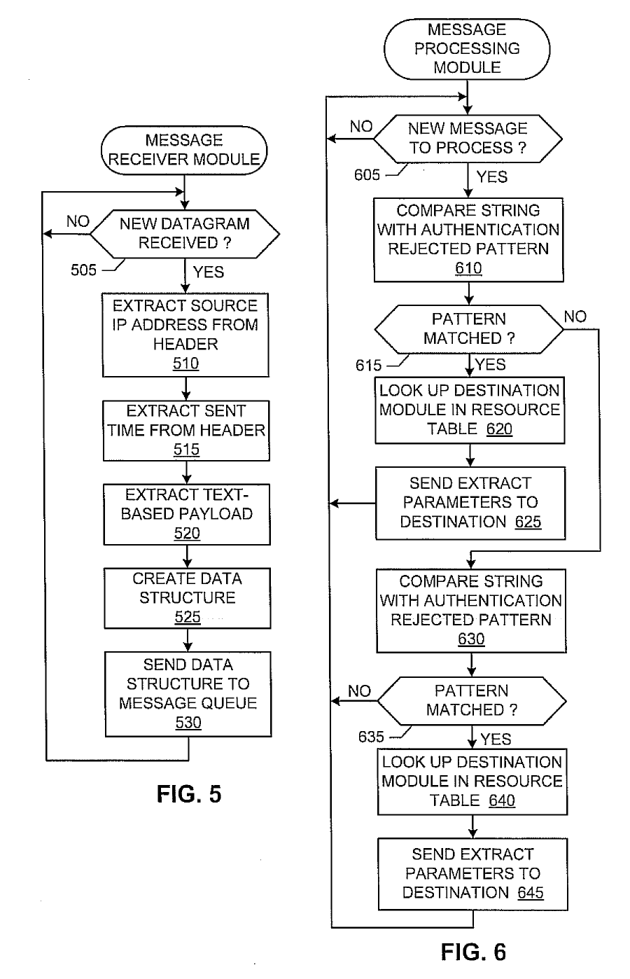

To receive messages from, for example, the example load balancer 145 of FIG. 1, the example message processing server 135 of FIG. 3 includes any number of message receiver modules, two of which are illustrated with reference numerals 305 and 306. As a UDP datagram is received, one of the example message receiver modules 305, 306 of FIG. 3 uses any of a variety of technique(s) and/or method(s) to extract from the header of the UDP packet the IP address of the sender (e.g., one of the example RADIUS servers 130, 131 of FIG. 1) and the time and/or date that the message was sent. The message receiver module 305, 306 also extracts the text-based contents of the payload of each UDP datagram (i.e., an authentication result string). The extracted source IP address, message sent time and text-based content are placed into a data structure having any variety of structure and/or format. In the example of FIG. 3, the data structure also includes an identifier that identifies which of the message receiver modules 305, 306 received the UDP datagram. An example implementation of the example message receiver modules 305, 306 is discussed below in connection with example machine accessible instructions of FIG. 5.

The example message receiver modules 305, 306 of FIG. 3 are bound to one or more specific UDP ports (e.g., port 514) and collect and/or listen for incoming messages received over that (those) UDP port(s). Additionally or alternatively, the message receiver modules 305, 306 may poll outside the message processing server 135 for messages. Moreover, the example message receiver modules 305, 306 of FIG. 1 may be implemented to handle and/or receive messages formatted and/or structured in accordance with any of a variety current and/or future standard(s) and/or protocol(s). The example message receiver modules 305, 306 may implement identical, similar and/or different functionality. For example, a first message receiver module 305, 306 listens for messages while a second receiver processing module 305, 306 polls for messages. The example message receiver modules 305, 306 may additionally or alternatively be configured with a list of valid source IP addresses. If a UDP datagram is received with a source IP address not on the list, then the UDP datagram is discarded. The list of valid source IP addresses may be provided to the example message receiver modules 305, 306 using, for example, a configuration file.

To process the messages received by the example message receiver modules 305, 306, the example message processing server 135 of FIG. 3 includes any number of message processing modules, two of which are shown in FIG. 3 with reference numerals 310, 311. The example message processor modules 310, 311 of FIG. 3 perform pattern matching to parse and/or extract data from received authentication result strings. The example message processing modules 310, 311 may implement identical, similar and/or different functionality. An example implementation of the example message processor modules 310, 311 of FIG. 3 is discussed below in connection with example machine accessible instructions of FIG. 6.

The example message processor modules 310, 311 of FIG. 3 extract authentication result data by comparing each authentication result string (i.e., the text-based content of a received UDP datagram) with one or more pre-defined search patterns. For an authentication result string that matches one of the pre-defined patterns, the example message processing modules 310, 311 then extracts parameter from the authentication result string. Pattern matching and/or parameter extraction may be performed using any of a variety of method(s), function(s), algorithm(s) and/or technique(s) such as regular expression matching.

An example search pattern for identifying and extracting parameters related to an authentication successful UDP datagram is:

<.*>(.*:[0-9][0-9]:[0-9][0-9]).* Request from (.*) \\(.*: User (.*) accepted

An example search pattern for identifying and extracting parameters related to an authentication rejected UDP datagram is:

<.*>(.*:[0-9][0-9]:[0-9][0-9]).* Request from (.*) \\(.*: User (.*) rejected \\((.*)\\)

These example patterns correspond to the example authentication result strings discussed above in connection with FIGS. 2A and 2B, respectively. In the example patterns, “.*” is a wildcard, and extracted parameters are between parenthesis. For instance, each of the example patterns start with “<.*>” which matches with any number and/or variety of characters located between the characters < and >. An example pattern matching process and/or thread compares an authentication result string to a pattern and, if the pattern matches, returns the value of the extracted parameters. For instance, the “(.*:[0-9][0-9]:[0-9][0-9])” portion of the example patterns matches against and extracts the timestamp. The “Request from (.*)” portion of the example patterns matches against and extracts the name of the router (e.g., the example NAS 125 of FIG. 1) that sent the authentication request. The “User (.*)” portion of the example patterns matches against and extracts the email address of the user requesting and/or initiating the authentication. In the authentication rejected example, the \\((.*)\\) portion matches against and extracts a rejection reason that is located between parenthesis.

For each received message, one of the example message processing modules 310, 311 of FIG. 3 compares the authentication result string with the authentication rejected pattern. If the rejected pattern matches the authentication result string, the message processing module 310, 311 uses the resource table 320 to select the destination module 315, 316 to be used. The example message processing module 310, 311 then sends the parameters extracted with the authentication rejected pattern to the selected destination module 315, 316.

If the authentication result string does not match the authentication rejected pattern, the example message processing module 310, 311 compares the authentication result string with the authentication accepted pattern. If the accepted pattern matches the authentication result string, the message processing module 310, 311 uses the resource table 320 to select the destination module 315, 316 to be used. The example message processing module 310, 311 then sends the parameters extracted with the authentication accepted pattern to the selected destination module 315, 316.

If the authentication result string does not match the authentication accepted pattern, the example message processing module 310, 311 of FIG. 3 discards the authentication result string. However, any of a variety of error handling may be applied to authentication result strings that do not match either pattern.

To send data extracted and/or parsed from received messages to an actual destination (e.g., one of the example destinations 140-142 of FIG. 1), the example message processing server 135 of FIG. 3 includes any number and/or variety of destination modules, two of which are illustrated in FIG. 3 with reference numbers 315 and 316. Each of the example destination modules 315, 316 of FIG. 3 provide and/or implement an interface to, an abstraction of and/or a wrapper for an actual destination. Persons of ordinary skill in the art will readily appreciate that each of the example destination modules 315, 316 are not the destination themselves but rather represent a standardized interface to one or more particular destinations and/or one or more particular types of destinations.

The example destination modules 315, 316 of FIG. 3 perform the necessary processing, formatting and/or routing so that authentication result data provided by the example message processing modules 310, 311 are correctly stored and/or delivered to the appropriate destination. The example destination modules 315, 316 implement, provide and/or utilize a common application programming interface (API) such that the message processing modules 310, 311 can be implemented independently of destinations and/or destination types. Example destination modules 315, 316 include an interface to store the authentication data in a database (e.g., the example database 142 of FIG. 1), to send the authentication result data in an email via an email server (e.g., the example email server 141 of FIG. 1) and/or to store the authentication result data in a file store on a server (e.g., the file server 140 of FIG. 1).

To facilitate the routing and/or sending of authentication result data between the message processing modules 310, 311 and the example destination modules 315, 316 the example message processing server 135 of FIG. 3 includes a resource table 320. The example resource table 320 of FIG. 3 contains, for example, a listing of destination(s) and/or destination module(s) 315, 316 as a function of one or more of message type (e.g., authentication request result), result (e.g., accept or reject), source IP address, email address of user requesting authentication, etc. Any of a variety of table(s), structure(s) and/or array(s) can be used for the example resource table 320. Moreover, the example resource table 320 can be store in any of a variety of memories and/or files. An example resource table 320 is a list of destinations indexed by message type (e.g., authentication result).

Once a message has been processed by a particular message processing module 310, 311, the example message processing module 310, 311 performs a look up in the example resource table 160 to select the destination module 315, 316 that is to be used to send and/or store the authentication result data. The example message processing module 310, 311 then sends the extracted parameters to the selected destination module 315, 315. The example destination module 315, 316 stores and/or sends the data, as appropriate, to the actual destination (e.g., the example database 142 of FIG. 1).

In the illustrated example of FIG. 1 and/or 3, the destination used for authentication result data is a database (e.g., the example database 142 of FIG. 1), and the example destination module(s) 315, 316 execute a structure query language (SQL) statement to store the parameters extracted by the message processing module 310, 311 in a database record. An example SQL statement to store an authentication successful record in a database is:

insert into db_authenticated (ROUTER_NAME, EMAIL,
ACCESS_TIME, HANDLE_NAME, AUTH_NAME,
CONNECT_STATUS) values (?, ?, to_date(?, ‘Mon-dd-hh24:mi:ss’), ?,
?, ‘accepted’)

An example SQL statement to store an authentication rejection record in a database is:

insert into db_rejected (ROUTER_NAME, REASON, EMAIL,
ACCESS_TIME, HANDLE_NAME, DOMAIN_NAME,
CONNECT_STATUS) values (?, ?, ?, to_date(?, ‘Mon-dd-hh24:mi:ss’),
?, ?, ‘rejected’)

In the example SQL statements, each “?” is a place holder for a parameter that is extracted and provided by a message processing module 310, 311 to the destination module 315, 316. Example database records are discussed below in connection with FIGS. 4A and 4B.

To queue and/or buffer the data structures created by the example message receiver modules 305, 306, the example message processing server 135 of FIG. 3 includes any of a variety of message queues 325. The example message queue 325 of FIG. 3 is a data structure based on multiple fixed-size buffers. An example fixed-size buffer holds the data structures for 100 datagrams. The size of the queue implemented by the example message queue 325 is dynamically adjusted up to a maximum size (e.g., 10,000 fixed-size buffers of 100 data structures each) depending upon the number of queued data structures (i.e., authentication result strings extracted from received UDP datagrams). If the number of queue data structures exceeds the maximum capacity (e.g., when a burst of UDP datagrams is received), the example message queue 325 can be configured to write the excess data structures to a file for later retrieval and/or processing.

In the example of FIG. 3, as each of the message processing modules 310, 311 is available and/or ready to process another data structure, the example message processing module 310, 311 reads and/or acquires the next data structure (e.g., the oldest) from the example message queue 325. Additionally or alternatively, if a particular message processing module 310, 311 only processes specific network message types, the particular message processing module 310, 311 reads the next data structure that corresponds to one of the supported network message types. There may be, additionally or alternatively, a plurality of message queues 325 for respective ones of the example message processing modules 310, 311. Each message processing module 310, 311 could then read the next data structure from their respective message queue 325. In general, any of a variety of method(s), structure(s) and/or technique(s) may be used to queue, provide and/or route network messages to one or more of the example message processing modules 310, 311, and/or to select and/or determine which of the example message processing modules 310, 311 will process any specific message. If a message is queued for potential processing by more than one of the example message processing modules 310, 311, persons of ordinary skill in the art will ready appreciate that only one of them will actually process the message.

Depending upon the configuration of the example message processing server 135, the message processing server 135 may include an additional message queue 330 between the example message processing modules 310, 311 and the example destination modules 315, 316. The implementation of the example message queue 330 is substantially similar to that discussed above for the example message queue 325 and, thus, will not be discussed further. The interested reader is referred to the discussion of the example message queue 325 presented above.

While example an example message processing server 135 has been illustrated in FIG. 3, the elements, modules, logic, sub-systems and/or devices illustrated in FIG. 3 may be combined, re-arranged, eliminated and/or implemented in any of a variety of ways. Further, the example message receiver modules 305, 306, the example message queues 325, 330, the example message processing modules 310, 311, the example destination modules 315, 316 and/or the example resource table 320 may be implemented by hardware, software, firmware and/or any combination of hardware, software and/or firmware. Moreover, the message processing server 135 may include additional elements, modules, logic, sub-systems and/or devices than those illustrated in FIG. 3 and/or may include more than one of any or all of the illustrated elements, modules, sub-systems and/or devices.

FIG. 4A is an example database record that may be used to store authentication result data extracted and/or determined from the authentication result string of an authentication accepted UDP datagram (e.g., the example string of FIG. 2A). To record the name of the NAS 125 by which the authentication request was initiated, the example database record of FIG. 4A includes a router name field 405. In the example of FIG. 1 and/or 3, the example router name field 405 of FIG. 4A contains the contents of the example router name element 220 of FIG. 2A or 2B.

To record the email address of the user who initiated the authentication request, the example database record of FIG. 4A includes an email address field 410. In the example of FIG. 1 and/or 3, the example email address field 410 of FIG. 4A contains the contents of the example email address element 230 of FIG. 2A or 2B.

To record the time at which the authentication request was initiated, the example database record of FIG. 4A includes an access time field 415. In the example of FIG. 1 and/or 3, the example access time field 415 of FIG. 4A contains the contents of the example timestamp element 210 of FIG. 2A or 2B.

To record the identity of the user who initiated the authentication request, the example database record of FIG. 4A includes a handle name field 420. In the example of FIG. 1 and/or 3, the example handle name field 420 of FIG. 4A contains the contents of the example email address element 230 of FIG. 2A or 2B.

To record the identity of the RADIUS server 130, 131 that handled the authentication request and sent the UDP datagram, the example database record of FIG. 4A includes an authorization name field 425. In the example of FIG. 1 and/or 3, the example authorization name field 425 of FIG. 4A contains the source IP address extracted from the header of the UDP datagram by a message receiver module 305, 306 of FIG. 3.

To record the IP address of a user device 110, 111 and 112 or the NAS 125, the example database record of FIG. 4A includes an IP address field 430. In the example of FIG. 1 and/or 3, the example IP address field 430 of FIG. 4A is left empty and/or contains a NULL character string.

To record the result of the authentication request, the example database record of FIG. 4A includes a connect status field 435. In the example of FIG. 1 and/or 3, the example connect status field 435 of FIG. 4A contains the contents of the example result element 235 of FIG. 2A or 2B. Thus, for an authentication accepted UDP datagram, the status field 435 of FIG. 4A contains the text string “accepted”

FIG. 4B is an example database record that may be used to store authentication result data extracted and/or determined from the authentication result string of an authentication rejected UDP datagram (e.g., the example string of FIG. 2B). Many of the fields of the example database record of FIG. 4B are identical to those discussed above in connection with FIG. 4A and, thus, the description of identical fields is not be repeated here. Instead, identical fields are illustrated with identical reference numerals in FIGS. 4A and 4B, and the interested reader is referred back to the descriptions provided above in connection with FIG. 4A.

Because the example database record illustrated in FIG. 4B corresponds to an authentication result string for an authentication rejected UDP datagram (e.g., the example string of FIG. 2B), the example status field 435 of FIG. 4B contains the text string “rejected”.

To record the reason for the authentication rejection, the example database record of FIG. 4B includes a reason field 440. In the example of FIG. 1 and/or 3, the example reason field 440 of FIG. 4B contains the contents of the reason element 240 of FIG. 2B.

To record the domain name of the user, the example database record of FIG. 4B includes a domain name field 445. In the example of FIG. 1 and/or 3, the example domain name field 445 of FIG. 4B is left empty and/or contains a NULL character string.

While example database records are illustrated in FIGS. 4A-B, persons of ordinary skill in the art will readily appreciate that the fields of FIGS. 4A-B could have been combined, split, ordered, re-arranged, and/or eliminated in any of a variety of ways. Further, database records may include additional fields than those illustrated in FIG. 4A and/or 4B and/or may include more than one of any or all of the illustrated fields. Persons of ordinary skill in the art will also readily appreciate that the methods and apparatus to process network messages disclosed herein can be used to create and/or store database records having any of a variety of fields, formats and/or structures.

FIGS. 5 and 6 are flowcharts representative of example machine accessible instructions that may be executed to implement the example message receiver modules 305, 306, the example message processing modules 310, 311 and/or, more generally, the example message processing server 135 of FIG. 1 and/or 3. The example machine accessible instructions of FIG. 5 and/or 6 may be executed by a processor, a controller and/or any other suitable processing device. For example, the example machine accessible instructions of FIG. 5 and/or 6 may be embodied in coded instructions stored on a tangible medium such as a flash memory, or random access memory (RAM) associated with a processor (e.g., the example processor 705 discussed below in connection with FIG. 7). Alternatively, some or all of the example flowcharts of FIGS. 5-6 may be implemented using an ASIC, a PLD, a FPLD, discrete logic, hardware, firmware, etc. Also, some or all of the example flowcharts of FIGS. 5-6 may be implemented manually or as combination(s) of any of the foregoing techniques, for example, a combination of firmware, software and/or hardware. Further, although the example machine accessible instructions of FIGS. 5-6 are described with reference to the flowcharts of FIGS. 5-6, persons of ordinary skill in the art will readily appreciate that many other methods of implementing the example message receiver modules 305, 306, the example message processing modules 310, 311 and/or, more generally, the example message processing server 135 of FIG. 1 and/or 3 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIG. 5 and/or 6 may be carried out sequentially and/or carried out in parallel by, for example, separate processing threads, processors, devices, circuits, etc.

The example machine readable instructions of FIG. 5 begin with a message receiver module (e.g., one of the example message receiver modules 305, 306 of FIG. 3) waiting for a new UDP datagram (i.e., message) to arrive (block 505). When a new message arrives (block 505), the message receiver module extracts the source IP address from the header of the UDP packet (block 510) and extracts the sent time from the header (block 515). The message receiver module also extracts the text-based payload (i.e., the authentication result string) from the UDP datagram (block 520). The message receiver module creates a data structure based on the extracted source IP address, the extracted sent time and the extract authentication result string (block 525) and sends the created data structure to a message queue (e.g., the example message queue 325 of FIG. 3). Control then returns to block 505 to wait to receive another UDP datagram.

The example machine readable instructions of FIG. 6 begin with a message processing module (e.g., one of the example message processing modules 310, 311 of FIG. 3) waiting for a data structure associated with a new message to process (block 605). When there is a data structure for a new message to process (block 605), the message processing module compares the authentication result string from the data structure with the pattern for an authentication rejection (block 610). If the authentication rejected pattern matches (block 615), the message processing module uses a resource table (e.g., the example resource table 320 of FIG. 3) to select the destination for the extracted authentication result data and/or parameters (block 620). The message processing module sends the extracted authentication result data and/or parameters to the selected destination (block 625). Control then returns to block 605 to wait for a data structure associated with a new message to process.

Returning to block 615, if the authentication rejection pattern does not match the authentication result string (block 615), the message processing module compares the authentication result string from the data structure with the pattern for an authentication acceptance (block 630). If the authentication accepted pattern matches (block 635), the message processing module uses a resource table (e.g., the example resource table 320 of FIG. 3) to select the destination for the extracted authentication result data and/or parameters (block 640). The message processing module sends the extracted authentication result data and/or parameters to the selected destination (block 645). Control then returns to block 605 to wait for a data structure associated with a new message to process.

Returning to block 635, if the authentication accepted pattern does not match the authentication result string (block 635), control returns to block 605 to wait for a data structure associated with a new message to process.

FIG. 7 is a schematic diagram of an example processor platform 700 that may be used and/or programmed to implement the example message receiver modules 305, 310, the example message processing modules 310, 311, the example destination modules 315, 315, the example resource table 320, the example message queues 325, 330 and/or, more generally, the example message processing server 135 of FIG. 1 and/or 3. For example, the processor platform 700 can be implemented by one or more general purpose single-thread and/or multi-threaded processors, cores, microcontrollers, etc. The processor platform 700 may also be implemented by one or more computing devices that contain any of a variety of concurrently-executing single-thread and/or multi-threaded processors, cores, microcontrollers, etc.

The processor platform 700 of the example of FIG. 7 includes at least one general purpose programmable processor 705. The processor 705 executes coded instructions 710 present in main memory of the processor 705 (e.g., within a RAM 715). The processor 705 may be any type of processing unit, such as a processor core, processor and/or microcontroller. The processor 705 may execute, among other things, the example machine accessible instructions of FIGS. 5 and/or 6 to perform network message processing. The processor 705 is in communication with the main memory (including a read-only memory (ROM) 720 and the RAM 715) via a bus 725. The RAM 715 may be implemented by dynamic RAM (DRAM), Synchronous DRAM (SDRAM), and/or any other type of RAM device, and ROM may be implemented by flash memory and/or any other desired type of memory device. Access to the memory 715 and 720 maybe controlled by a memory controller (not shown). The RAM 715 may be used to store and/or implement, for example, the example resource table 320 and/or the example message queues 325, 330.

The processor platform 700 also includes an interface circuit 730. The interface circuit 730 may be implemented by any type of interface standard, such as an external memory interface, serial port, general purpose input/output, etc. One or more input devices 735 and one or more output devices 740 are connected to the interface circuit 730. The input devices 735 and/or output devices 740 may be used to, for example, implement interfaces to, for and/or between any or all of the example message receiver modules 305, 310, the example message processing modules 310, 311, the example destination modules 315, 315, the example resource table 320, the example message queues 325, 330 of FIG. 3 and/or, more generally, between the example message processing server 135 and any or all of the example load balancer 145, the RADIUS servers 130, 131 and/or the example destinations 140-142 of FIG. 1.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. For instance, RADIUS servers, IETF RFC 2865 and UDP datagrams represent examples of the current state of the art. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of processing authentication result messages in a network having a server and at least one network device that sends an authentication result message to the server, the method comprising:
receiving the authentication result message from the network device;
providing the authentication result message to one of two or more processing modules of the server, the one of two or more processing modules to process the authentication result message to extract data from the authentication result message; and
sending the data to a destination.

2. A method as defined in claim 1, wherein the at least one network device is a Remote Authentication Dial-In User Service (RADIUS) server, and the authentication result message is sent in response to an authentication request.

3. A method as defined in claim 1, wherein the destination is at least one of a database entry, an electronic mail address, a data file or a text file.

4. A method as defined in claim 1, wherein the authentication result message is transported in a user datagram protocol (UDP) datagram packet.

5. A method as defined in claim 4, wherein the data is carried in a text-based payload of the UDP datagram packet.

6. A method as defined in claim 1, wherein receiving the authentication result message from the network device comprises:
extracting the source Internet protocol (IP) address from the header of the authentication result message; and
extracting the text-based payload of the authentication result message, the selected one of the two or more message processing modules to extract the data from the text-based payload.

7. A method as defined in claim 1, wherein extracting data from the authentication result message comprises comparing a portion of the authentication result message with a search pattern, wherein the data is extracted if the search pattern matches the portion of the authentication result.

8. A method as defined in claim 1, wherein the two processing modules are parallel threads and execute substantially identical machine accessible instructions.

9. A method as defined in claim 1, wherein the two processing modules are carried out by at least one of a single-threaded processor, a multi-threaded processor or a computing device that contains two or more concurrently-executing processors.

10. A method as defined in claim 1, wherein sending the data to the destination comprises:
selecting a destination module based on at least one of a source associated with the authentication result message, a field contained in the authentication result message, or a result computed using one or more fields contained in the authentication result message; and
passing the data to the destination module, the destination module to send the data to the destination.

11. The method as defined in claim 10, further comprising queuing the data prior to passing the data to the destination module, the destination module to receive the data via the queue.

12. A method as defined in claim 1, further comprising adding the received authentication result message to a queue, the one of two processing module to receive the authentication result message via the queue.

13. A method as defined in claim 1, further comprising:
receiving multiple authentication result messages from other network devices;
balancing a load between the two or more processing modules by allocating received messages between the two or more processing modules.

14. An apparatus comprising:
one or more network devices; and
a message processing server including:
a message receiver module to receive a network message from a one of the one or more network devices;
one or more message processing modules to extract a parameter from the received message; and
a destination module to send the parameter to a destination.

15. An apparatus as defined in claim 14, further comprising a load balancer to receive the network message and to route the network message to the message processing server.

16. An apparatus as defined in claim 15, further comprising a second message processing server, the load balancer to route the network message to the first or the second message processing server based on a load of the first message processing server.

17. An apparatus as defined in claim 14, further comprising a message queue to pass the authentication result message between the message receiver module and the one or more message processing modules.

18. An apparatus as defined in claim 14, wherein the one or more network devices are Remote Authentication Dial-In User Service (RADIUS) servers, and the network message is an authentication result message sent in response to an authentication request.

19. An apparatus as defined in claim 18, further comprising a network access server to send the authentication request.

20. An apparatus as defined in claim 14, wherein the authentication result messages are transported in user datagram protocol (UDP) packets.

21. An apparatus as defined in claim 14, wherein the one or more message processing modules extract the parameter from the received message by comparing a portion of the authentication result message with a search pattern, wherein the data is extracted if the search pattern matches the portion of the authentication result message.

22. An apparatus as defined in claim 14, wherein the one or more message processing modules is to select between the destination module and a second destination module based on at least one of a source associated with the authentication result message, a field contained in the authentication result message, or a result computed using one or more fields contained in the authentication result message, and to pass the data to the selected destination processor.

23. An apparatus as defined in claim 22, further comprising a resource table used to select between the destination module and the second destination module based on the at least one of the source associated with the authentication result message, the field contained in the authentication result message, or the result computed using one or more fields contained in the authentication result message.

24. An apparatus as defined in claim 14, wherein the message receiver module receives the authentication result message by polling the one or more network devices.

25. An apparatus as defined in claim 14, further comprising a multi-threaded processor to execute the one or more message processing modules.

26. An apparatus as defined in claim 14, further comprising two or more concurrently-executing processors to execute the one or more message processing modules.

27. An article of manufacture storing machine accessible instructions which, when executed, cause a machine to:
receive first and second authentication result messages at a server;
provide the first authentication result message to a first processing thread of the server, the first processing module to process the first authentication result message to extract first data from the first authentication result message;
provide the second authentication result message to a second processing thread of the server, the second processing module to process the second authentication result message to extract second data from the second authentication result message;
send the first data to a first destination; and
send the second data to a second destination.

28. An article of manufacture as defined in claim 27, wherein the first and the second destinations are at least one of a same type of destination or a same destination.

29. An article of manufacture as defined in claim 27, wherein the first and the second processing threads execute substantially similar machine accessible instructions in parallel.

30. An article of manufacture as defined in claim 27, wherein the first and the second authentication result messages are received from a Remote Authentication Dial-In User Service (RADIUS) server, and the first and the second authentication result messages are sent in response to respective ones of first and second authentication requests.

31. An article of manufacture as defined in claim 27, wherein the machine accessible instructions, when executed, cause the machine to:
receive the first authentication result message in a user datagram protocol (UDP) datagram packet;
extract a text-based payload of the UDP datagram packet; and
extract the first data from the text-based payload.

32. An article of manufacture as defined in claim 31, wherein the machine accessible instructions, when executed, cause the machine to extract the first data from the text-based payload by comparing a portion of the text-based payload with a search pattern, wherein the first data is extracted if the search pattern matches the portion of the text-based payload.

33. An article of manufacture as defined in claim 27, wherein the machine accessible instructions, when executed, cause the machine to send the first data to the first destination by:
selecting a destination module based on at least one of a source associated with the first authentication result message, a field contained in the first authentication result message, or a result computed using one or more fields contained in the first authentication result message; and
passing the first data to the selected destination module, the selected destination module to send the first data to the first destination.
